(19) United States
(12) Patent Application Publication
(10) Pub. No.: US 2008/0190289 A1
(43) Pub. Date: Aug. 14, 2008

(54) Gas Odorous Substance Separation

(76) Inventors: Ulrich Muller, Neustadt (DE); Markus Schubert, Ludwigshafen (DE); Michael Hesse, Worms (DE); Hermann Putter, Neustadt (DE); Helge Wessel, Mannheim (DE); Jurgen Huff, Ludwigshafen (DE); Marcus Guzmann, Muhlhausen (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/913,977

(22) PCT Filed: May 15, 2006
(86) PCT No.: PCT/EP06/62312

§ 371 Date: Nov. 9, 2007

(30) Foreign Application Priority Data
May 18, 2005 (DE) 10 2005 022 844.5

(51) Int. Cl. B01D 35/143; B01D 53/00

(52) U.S. Cl. 95/25; 95/273

(57) ABSTRACT

The present invention relates to a method for separating off odor substances from gases, comprising gas with at least one filter comprising a porous metal-organic framework material, the framework material comprising at least one, at least bidentate, organic compound which is bound by coordination to at least one metal ion.

The present invention relates to methods for separating off odor substances from gases using porous framework materials.

Odor substances play an important role in the objective and subjective evaluation of the quality of gases, or gas mixtures such as air, in which the odor substances are present in dissolved form.

The most varied types of gases and odor substances can be involved, as regards their chemical properties.

One of the most popular means for separating off odor substances from gases is adsorption of the odor substances to activated carbon which is usually fixed in a filter. In order to accelerate the filtering of the air, usually the gas to be filtered, for example indoor air, is drawn in using suitable apparatuses such as a fan and ejected again via the filter and thus again released to the ambient air.

The type of filters or filter systems used and also the deposition of the adsorbent in such filters depend greatly on the underlying use and are extensively described in the prior art for the respective applications.

EP-A 1 344 669 describes the removal of harmful impurities from the air like nitric oxides in the compartment of a means of transport with the aid of adsorption filters.

EP-A 465 371 describes a chemical filter with an active filter section and a general filter section for the removal of toxic air pollutants.

Although it is possible to increase the efficiency of the filters by optimized filter systems and intake mechanisms, the adsorption capacity of the adsorbent in this case acquires a critical role.

It is found in this case that adsorbents such as activated carbon can be disadvantageous with respect to their adsorption behavior and safety. The lower adsorption capacity of the adsorbents of the prior art and also their low selectivity necessitates higher volumes of residues to be disposed of.

The object of the present invention is thus to provide alternative adsorbents for methods for separating off odor substances which can have better properties than those of the prior art. In particular, the inventive adsorbents are to be able to be recycled as far as possible without significant losses of adsorption capacity.

The object is achieved by a method for separating off odor substances from gases the step comprising

contacting the gas with at least one filter comprising a porous metal-organic framework material, the framework material comprising at least one, at least bidentate, organic compound which is bound by coordination to at least one metal ion.

This is because it has been found that separating off odor substances from gases in an efficient manner can be carried out by using porous metal-organic framework (MOF) materials.

In the context of the present invention, for simplicity, the term “gas” is also used when gas mixtures, for example air, are involved. In the case of the relevant gases, it is only necessary that they are in the gaseous state during the contacting.

Preferably, the gas has a boiling point or boiling range which is below room temperature. However, it is also possible that higher-boiling fluid systems are used if these are, for example, released as off-gases at elevated temperature, and are fed to the MOF before their condensation.

Preferably, the gas is natural gas, biogas, off-gas, air, exhaust air or inert gas. More preference is given to natural gas, biogas, air and exhaust air. In particular, preference is given to biogas, air and exhaust air.

The gas can be present in open, or at least partially closed, systems. In particular in the case of natural gas and biogas, this can be pipes, pipelines, tank vessels, transport vessels or natural gas containers, as are used, for example, for storage in the ground, or as tanks for motor vehicles. In the case of off-gases, these are preferably industrial off-gases, or those off-gases as are produced in combustion operations (e.g. in combustion engines). In addition, preferably the gas is internal air in buildings or rooms such as in living rooms and dining rooms, or in particular in kitchens. The internal air in means of locomotion such as automobiles, trucks, trains or ships may also be mentioned in this case. Likewise, the internal air in appliances, for example dishwashers, may be mentioned.

In particular in the cases in which the gas is natural gas, air, exhaust air or inert gas, the odor substance can originally be a constituent of a liquid (for example water or petroleum) or solid medium which then transfers into the phase of the gas situated above the liquid or solid surface and then is removed from this. For example, the gas can be a gas within packaging (ambient gas) of solid articles which in the course of time release odor substances within the package to the ambient gas. In this case the ambient gas is air or inert gas. A further example is polymers in which monomers which were not reacted in the production of the polymers, but are still remaining in the polymer and in the course of time are being released to the ambient gas, for example the internal air, and are the odor substances to be separated off. Likewise, further highly volatile components may be present in the polymer which can be released to the ambient gas. In this case, for example, initiators or stabilizers and other additives may be mentioned. A survey of such components is given in Plastics additive Handbook, Hans Zweifel, Hanser Verlag, Munich (ISBN 3-446-21654-5). The solid medium may also consist of small particles like smoke.

The odor substance can be present in the gas in dissolved form, or be itself gaseous and thus be a “constituent” of a gas mixture. In the context of the present invention, the term “odor substance” is likewise used for simplification, even when it is a mixture of a plurality of odor substances. Odor substances in this case are substances which can be perceived via the human sense of smell.

Preferably, the odor substance is a volatile organic or inorganic compound which comprises at least one of the elements nitrogen, phosphorus, oxygen, sulfur, fluorine, chlorine, bromine or iodine, or is an unsaturated or aromatic hydrocarbon or a saturated or unsaturated aldehyde or ketone. More preferred elements are nitrogen, oxygen, phosphorus, sulfur, chlorine, bromine; in particular preference is given to nitrogen, oxygen, phosphorus and sulfur.

In particular, the odor substance is ammonia, halogens, hydrogen sulfide, sulfur oxides, nitrogen oxides, ozone, cyclic or acyclic amines, thiols, thioethers and also aldehydes, ketones, esters, ethers, nitriles, acids or alcohols. Particular preference is given to ammonia, hydrogen sulfide, organic acids (preferably acetic acid, propionic acid, butyric acid, isobutyric acid, valeric acid, isovaleric acid, caproic acid, heptylic acid, lauric acid, perlargonic acid) and also cyclic or acyclic hydrocarbons which comprise nitrogen, halogens or sulfur and also saturated or unsaturated aldehydes, such as hexanal, heptanal, octanal, nonanal, decanal, octenal or nonenal and, in particular, volatile aldehydes such as butyraldehyde, propionaldehyde, acetaldehyde, formaldehyde, acrolein, crotonic aldehyd, styrene, acrylic acid, esters thereof and other ethylenic unsaturated compounds, acetonitrile, propionitrile, acetone, butanone, and furthermore fuels such as gasoline, diesel (constituents).

The odor substances can be fragrances which are used, for example for producing perfumes. Fragrances or oils which release such fragrances which may be mentioned by way of example are: essential oils, basil oil, geranium oil mint oil, cananga oil, cardamom oil, lavender oil, peppermint oil, nutmeg oil, camille oil, eucalyptus oil, rosemary oil, lemon oil, lime oil, orange oil, bergamot oil, clary oil, coriander oil, cypress oil, 1,1-dimethoxy-2-pherylethane, 2,4-dimethyl-4-phenyltetrahydrofuran, dimethyltetrahydrobenzaldehyde, 2,6-dimethyl-7-octen-2-ol, 1,2-diethoxy-3,7-dimethyl-2,6-octadiene, phenylacetaldehyde, rose oxide, ethyl 2-methylpentanoate, 1-(2,6,6-trimethyl-1,3-cyclohexadien-1-yl)-2-buten-1-one, ethylvanillin, 2,6-dimethyl-2-octenol, 3,7-dimethyl-2-octenol, tert-butyl cyclohexylacetate, anisyl acetates, allyl cyclohexyloxyacetate, ethyllinalool, eugenol, coumarin, ethyl acetoacetate, 4-phenyl-2,4,6-trimethyl-1,3-dioxane, 4-methylene-3,5,6,6-tetramethyl-2-heptanone, ethyl tetrahydrosafranate, geranylnitrile, cis-3-hexen-1-ol, cis-3-hexenyl acetate, cis-3-hexenyl methyl carbonates, 2,6-dimethyl-5-hepten-1-al, 4-(tricyclo[5.2.1.0]decylidene)-8-butanal, 5-(2,2,3-trimethyl-3-cyclopentenyl)-3-methylpentan-2-ol, p-tert-butyl-alpha-methylhydrocinnamaldehyde, ethyl [5.2.1.0]tricyclodecanecarboxylate, geraniol, citronellol, citral, linalool, linalyl acetate, ionones, phenylethanol or mixtures thereof.

In the context of the present invention, a volatile odor substance preferably has a boiling point or boiling range of below 300° C. More preferably, the odor substance is a highly volatile compound or mixture. In particular preferably, the odor substance has a boiling point or boiling range of below 250° C., more preferably below 230° C., in particular preferably below 200° C.

Preference is likewise given to odor substances which have a high volatility. The vapor pressure can be used as index of the volatility. In the context of the present invention, a volatile odor substance preferably has a vapor pressure of greater than 0.001 kPa (20° C.). More preferably, the odor substance is a highly volatile compound or mixture. In particular preferably, the odor substance has a vapor pressure of greater than 0.01 kPa (20° C.), more preferably a vapor pressure of greater than 0.05 kPa (20° C.). Particularly preferably, the odor substances have a vapor pressure of greater than 0.1 kPa (20° C.).

The shape and nature of the filter can be chosen as desired and adapted to the corresponding use. Usable filter systems are known to those skilled in the art. As a simple example of a filter, a plastic bag which has pores or small holes and is gas permeable can be used which is packed with the MOF material, preferably as shaped body. Likewise, popular air or exhaust air filters can be used. Also, use can be made of filters as are used in steam exhaust hoods, air conditioning apparatus, circulation systems, exhaust units, vacuum cleaners, or else in industrial plants. The MOF material can also be packed in cartridges, preferably having a cylindrical shape, which are closed at the end via porous gas-permeable material and through which the medium to be purified can flow. The material used for the packaging should preferably be thermally stable, so that the filter or the filter unit can be cleaned, for example, for recycling, for example, by thermal desorption. For this suitable materials are glass, metal, for example aluminum, or plastics known to those skilled in the art, such as poly(vinyl chloride), polystyrene, poly(methyl methacrylate), polycarbonate, polyvinylpyrrolidone, polyethersulfone, polyesters, epoxy resins, polyacetal etc. The MOF material I suitable for passive use (contact with the gas by convection or existing flows) and for active use (contact with the gas intensified by pumping, pressure differences etc.). It can be used for pretreating the interior air in transport means such as vehicles, aircraft, rail vehicles, ships, but also in exhaust air filters in internal combustion engines, electric and electronic apparatuses. Likewise, it is used for purifying air in office rooms, living rooms and storage rooms, vessels, containers, refrigerators, gas masks, shelters, extractor hoods, in nuclear plants, e.g. for radioactive material, vehicles etc. and also in the case of rubber semi-manufactured products, smoke goods and finished components.

Preferably, the filter is regenerable. This is possible in principle, since the adsorption of the odor substance to the MOF material is reversible. Thus, desorption can be performed, for example, by temperature elevation or pressure reduction. The odor substance can also be displaced by purge gas. The manner in which a desorption can be carried out is known to those skilled in the art. Instructions on this may be found, for example, in Werner Kast, “Adsorption aus der Gasphase” [Adsorption from the gas phase], Verlag VCH, Weinheim, 1988.

Further preferably, the saturation of the filter (filter material) with odor substances may be established by a color change of the MOF. This is the case, in particular, if copper is used as metal ion in the MOF. This makes possible for the user simple visual examination of the remaining capacity of the filter medium, in particular when a transparent packaging material is used.

The porous metal-organic framework material comprises at least one, at least bidentate, organic compound bound by coordination to at least one metal ion. This metal-organic framework material (MOF) is described, for example, in U.S. Pat. No. 5,648,508, EP-A-0 790 253, M. O-Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023 and DE-A-101 11 230.

The MOFs according to the present invention comprise pores, in particular micropores and/or mesopores. Micropores are defined as those having a diameter of 2 nm or less and mesopores are defined by a diameter in the range from 2 to 50 nm, in each case in accordance with the definition as specified by Pure Applied Chem. 45, page 71, in particular on page 79 (1976). The presence of micropores and/or mesopores can be studied using sorption measurements, these measurements determining the absorption capacity of the MOF for nitrogen at 77 Kelvin as specified in DIN 66131 and/or DIN 66134.

Preferably, the specific surface area, calculated according to the Langmuir model (DIN 66131, 66134) for an MOF in powder form is greater than 5 m²/g, more preferably greater than 10 m²/g, more preferably greater than 50 m²/g, still more preferably greater than 500 m²/g, still more preferably greater than 1000 m²/g, and particularly preferably greater than 1500 m²/g.

MOF shaped bodies can have a lower specific surface area; preferably, however, greater than 10 m²/g, more preferably greater than 50 m²/g, still more preferably greater than 500 m²/g.

The metal component in the framework material according to the present invention is preferably selected from the groups Ia, Ila, IIIa, IVa to VIIIa and Ib to VIb. Particular preference is given to Mg, Ca, Sr, Ba, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, Tl, Si, Ge, Sn, Pb, As, Sb and Bi. More preference is given to Zn, Cu, Ni, Pd, Pt, Ru, Rh and Co. In particular preference is given to Zn, Al, Ni and Cu. With respect to the ions of these elements, those which may particularly be mentioned are Mg²⁺, Ca²⁺, Sr²⁺, Ba²⁺, Sc³⁺, Y³⁺, Ti⁴⁺, Zr⁴⁺, Hf⁴⁺, V⁴⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu³⁰, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺and Bi⁺.

The term “at least bidentate organic compound” designates an organic compound which comprises at least one functional group which is able to form, to a given metal ion, at least two, preferably two, coordinate bonds, and/or to two or more, preferably two metal atoms, in each case one coordinate bond.

As functional groups via which said coordinate bonds can be formed, in particular, for example the following functional groups may be mentioned: —CO₂H, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(RSH)₂, —C(RSH)_{3>}, —CH(RNH₂)_{2>}, —C(RNH₂)₃, —CH(ROH)₂, —C(ROH)₃, —CH(RCN)₂, —C(RCN)_{3>}, where R, for example, is preferably an alkylene group having 1, 2, 3, 4 or 5 carbon atoms, for example a methylene, ethylene, n-propylene, i-propylene, n-butylene-, i-butylene, tert-butylene or n-pentylene group, or an aryl group comprising 1 or 2 aromatic nuclei, for example 2 C₆ rings which, if appropriate, can be condensed and, independently of one another, can be suitably substituted by at least in each case one substituent, and/or which independently of one another, in each case, can comprise at least one heteroatom, for example N, O and/or S. According to likewise preferred embodiments, functional groups may be mentioned in which the abovementioned radical R is not present. In this respect, inter alia, —CH(SH)₂, —C(SH)₃, —CH(NH₂)₂, —C(NH₂)₃, —CH(OH)₂, —C(OH)₃, —CH(CN)₂ or —C(CN)₃ may be mentioned.

The at least two functional groups can in principle be bound to any suitable organic compound, provided that it is ensured that the organic compound having these functional groups is capable of forming the coordinate bond and for producing the framework material.

Preferably, the organic compounds which comprise the at least two functional groups are derived from a saturated or unsaturated aliphatic compound or an aromatic compound or a compound which is both aliphatic and aromatic.

The aliphatic compound or the aliphatic part of the both aliphatic and also aromatic compound can be linear and/or branched and/or cyclic, a plurality of cycles also being possible per compound. Further preferably, the aliphatic compound or the aliphatic part of the both aliphatic and also aromatic compound comprises 1 to 15, further preferably 1 to 14, further preferably 1 to 13, further preferably 1 to 12, further preferably 1 to 11, and in particular preferably 1 to 10 carbon atoms, for example 1, 2, 3, 4, 5, 6, 7, 8, 9 or 10 carbon atoms. In particular preference is given here to inter alia methane, adamantane, acetylene, ethylene, or butadiene.

The aromatic compound or the aromatic part of the not only aromatic but also aliphatic compound can have one or else a plurality of nuclei, for example two, three, four or five nuclei, the nuclei being able to be present separately from one another and/or at least two nuclei being able to be present in condensed form.

Particularly preferably, the aromatic compound, or the aromatic part of the not only aliphatic but also aromatic compound has one, two or three nuclei, one or two nuclei being particularly preferred. Independently of one another, in addition, each nucleus of said compound can comprise at least one heteroatom, for example N, O, S, B, P, Si, Al, preferably N, O and/or S. Further preferably, the aromatic compound, or the aromatic part of the not only aromatic but also aliphatic compound, comprises one or two C₆ nuclei, the two being present either separately from one another or in condensed form. In particular, as aromatic compounds, benzene, naphthalene and/or biphenyl and/or bipyridyl and/or pyridyl may be mentioned.

For example, inter alia, trans-muconic acid or fumaric acid or phenylenebisacrylic acid may be mentioned.

For example, in the context of the present invention, mention may be made of dicarboxylic acid, such as oxalic acid, succinic acid, tartaric acid, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidodicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200 dicarboxylic acid, 3,6-dioxaoctanedicarboxylic acid, 3,5-cyclohexadiene-1,2-dicarboxylic acid, octadicarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-dinaphthyl-S,S′-dicarboxylic acid, 7-chloro-8-methylquinoline-2,3-dicarboxylic acid, 1-anilinoanthraquinone-2,4′-dicarboxylic acid, poly-tetrahydrofuran-250-dicarboxylic acid, 1,4-bis(carboxymethyl)piperazine-2,3-dicarboxylic-acid, 7-chloroquinoline-3,8-dicarboxylic acid, 1-(4-carboxy)phenyl-3-(4-chloro)phenylpyrazoline-4,5-dicarboxylic acid, 1,4,5,6,7,7,-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, O-hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyletherdiimidodicarboxylic acid, 4,4′-diaminodiphenylmethanediimidodicarboxylic acid, 4,4′-diaminodiphenylsulfonediimidodicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, diphenyl-ether-4,4′-dicarboxylic acid, imidazole-4,5-dicarboxylic acid, 4(1 H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid 1,14-tetradecanedicarboxylic acid, 5,6-dehydronorbornane-2,3-dicarboxylic acid or 5-ethyl-2,3-pyridinedicarboxylic acid, tricarboxylic acids such as

2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid, or tetracarboxylic acids such as

1,1-dioxidoperylo[1,12-bcd]thiophene-3,4,9,10-tetracarboxylic acid, perylenetetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

Very particularly preferably, use is made of optionally at least monosubstituted mono-, di-, tri-, tetranuclear or higher nuclear aromatic di-, tri- or tetracarboxylic acids, each of the nuclei being able to comprise at least one heteroatom, two or more nuclei being able to comprise identical or different heteroatoms. For example, preference is given to mononuclear dicarboxylic acids, mononuclear tricarboxylic acids, mononuclear tetracarboxylic acids, dinuclear dicarboxylic acids, dinuclear tricarboxylic acids, dinuclear tetracarboxylic acids, trinuclear dicarboxylic acids, trinuclear tricarboxylic acids, trinuclear tetracarboxylic acids, tetranuclear dicarboxylic acids, tetranuclear tricarboxylic acids and/or tetranuclear tetracarboxylic acids. Suitable heteroatoms are, for example N, O, S, B, P, Si, Al, preferred heteroatoms in this case are N, S and/or O. Suitable substituent which may be mentioned in this respect is, inter alia, —OH, a nitro group, an amino group or an alkyl or alkoxy group.

In particular preferably, as at least bidentate organic compounds, use is made of acetylenedicarboxylic acid (ADC), benzenedicarboxylic acids, naphthalene-dicarboxylic acids, biphenyldicarboxylic acids, for example 4,4′-biphenyldicarboxylic acid (BPDC), bipyridinedicarboxylic acids, for example 2,2′-bipyridinedicarboxylic acids, for example 2,2′-bipyridine-5,5-dicarboxylic acid, benzenetricarboxylic acids, for example 1,2,3-benzenetricarboxylic acid or 1,3,5-benzenetricarboxylic acid (BTC), adamantanetetracarboxylic acid (ATC), adamantanedibenzoate (ADB) benzenetribenzoate (BTB), methanetetrabenzoate (MTB), adamantanetetrabenzoate, or dihydroxyterephthalic acids, for example 2,5-dihydroxyterephthalic acid (DHBDC).

Very particularly preferably, use is made of, inter alia, isophthalic acid, terephthalic acid, 2,5-dihydroxyterephthalic acid, 1,2,3-benezenetricarboxylic acid, 1,3,5-benzenetricarboxylic acid, or 2,2-bipyridine-5,5′-dicarboxylic acid.

In addition to these at least bidentate organic compounds, the MOF can also comprise one or more monodentate ligands.

Suitable solvents for producing the MOFs are, inter alia, ethanol, dimethylformamide, toluene, methanol, chlorobenzene, diethylformamide, dimethyl sulfoxide, water, hydrogen peroxide, methylamine, sodium hydroxide solution, acetonitrile, benzyl chloride, triethylamine, ethylene glycol and mixtures thereof. Further metal ions, at least bidentate organic compounds and solvents for producing MOFs are described, inter alia, in U.S. Pat. No. 5,648,508 or DE-A 101 11 230.

The pore size of the MOF can be controlled by selection of the suitable ligand and/or of the at least bidentate organic compound. It is generally true that the greater the organic compound, the greater is the pore size. Preferably, the pore size is 0.2 nm to 30 nm, particularly preferably the pore size is in the range from 0.3 nm to 3 nm, based on the crystalline material.

In an MOF shaped body, however, larger pores also occur, the size distribution of which can vary. Preferably, however, more than 50% of the total pore volume, in particular more than 75%, is formed by pores having a pore diameter of up to 1000 nm. Preferably, however, a majority of the pore volume is formed by pores of two diameter ranges. It is therefore further preferred if more than 25% of the total pore volume, in particular more than 50% of the total pore volume, is formed by pores which are in a diameter range from 100 nm to 800 nm, and if more than 15% of the total pore volume, in particular more than 25% of the total pore volume, is formed by pores which are in a diameter range of up to 10 nm. The pore distribution can be determined by means of mercury porosimetry.

Examples of MOFs are given hereinafter. In addition to the designation of the MOF, the metal and also the at least bidentate ligand, in addition the solvent and also the cell parameters (angle α, β and γ and also the distances A, B and C in Å) are given. The latter were determined by X-ray diffraction.

| | Constituents | | | | | | | | |
|---|---|---|---|---|---|---|---|---|---|
| | molar ratio | | | | | | | | Space |
| MOF-n | M + L | Solvents | α | β | γ | a | b | c | group |
| MOF-0 | Zn(NO₃)₂•6H₂O | Ethanol | 90 | 90 | 120 | 16.711 | 16.711 | 14.189 | P6(3)/ |
| | H₃(BTC) | | | | | | | | Mcm |
| MOF-2 | Zn(NO₃)₂•6H₂O | DMF | 90 | 102.8 | 90 | 6.718 | 15.49 | 12.43 | P2(1)/n |
| | (0.246 mmol) | Toluene | | | | | | | |
| | H₂(BDC) | | | | | | | | |
| | 0.241 mmol) | | | | | | | | |
| MOF-3 | Zn(NO₃)₂•6H₂O | DMF | 99.72 | 111.11 | 108.4 | 9.726 | 9.911 | 10.45 | P-1 |
| | (1.89 mmol) | MeOH | | | | | | | |
| | H₂(BDC) | | | | | | | | |
| | (1.93 mmol) | | | | | | | | |
| MOF-4 | Zn(NO₃)₂•6H₂O | Ethanol | 90 | 90 | 90 | 14.728 | 14.728 | 14.728 | P2(1)3 |
| | (1.00 mmol) | | | | | | | | |
| | H₃(BTC) | | | | | | | | |
| | (0.5 mmol) | | | | | | | | |
| MOF-5 | Zn(NO₃)₂•6H₂O | DMF | 90 | 90 | 90 | 25.669 | 25.669 | 25.669 | Fm-3m |
| | (2.22 mmol) | Chloro- | | | | | | | |
| | H₂(BDC) | benzene | | | | | | | |
| | (2.17 mmol) | | | | | | | | |
| MOF-38 | Zn(NO₃)₂•6H₂O | DMF | 90 | 90 | 90 | 20.657 | 20.657 | 17.84 | I4cm |
| | (0.27 mmol) | Chloro- | | | | | | | |
| | H₃(BTC) | benzene | | | | | | | |
| | (0.15 mmol) | | | | | | | | |
| MOF-31 | Zn(NO₃)₂•6H₂O | Ethanol | 90 | 90 | 90 | 10.821 | 10.821 | 10.821 | Pn(−3)m |
| Zn(ADC)₂ | 0.4 mmol | | | | | | | | |
| | H₂(ADC) | | | | | | | | |
| | 0.8 mmol | | | | | | | | |
| MOF-12 | Zn(NO₃)₂•6H₂O | Ethanol | 90 | 90 | 90 | 15.745 | 16.907 | 18.167 | Pbca |
| Zn₂(ATC) | 0.3 mmol | | | | | | | | |
| | H₄(ATC) | | | | | | | | |
| | 0.15 mmol | | | | | | | | |
| MOF-20 | Zn(NO₃)₂•6H₂O | DMF | 90 | 92.13 | 90 | 8.13 | 16.444 | 12.807 | P2(1)/c |
| ZnNDC | 0.37 mmol | Chloro- | | | | | | | |
| | H₂NDC | benzene | | | | | | | |
| | 0.36 mmol | | | | | | | | |
| MOF-37 | Zn(NO₃)₂•6H₂O | DEF | 72.38 | 83.16 | 84.33 | 9.952 | 11.576 | 15.556 | P-1 |
| | 0.2 mmol | Chloro- | | | | | | | |
| | H₂NDC | benzene | | | | | | | |
| | 0.2 mmol | | | | | | | | |
| MOF-8 | Tb(NO₃)₃•5H₂O | DMSO | 90 | 115.7 | 90 | 19.83 | 9.822 | 19.183 | C2/c |
| Tb₂ (ADC) | 0.10 mmol | MeOH | | | | | | | |
| | H₂ADC | | | | | | | | |
| | 0.20 mmol | | | | | | | | |
| MOF-9 | Tb(NO₃)₃•5H₂O | DMSO | 90 | 102.09 | 90 | 27.056 | 16.795 | 28.139 | C2/c |
| Tb₂ (ADC) | 0.08 mmol | | | | | | | | |
| | H₂ADB | | | | | | | | |
| | 0.12 mmol | | | | | | | | |
| MOF-6 | Tb(NO₃)₃•5H₂O | DMF | 90 | 91.28 | 90 | 17.599 | 19.996 | 10.545 | P21/c |
| | 0.30 mmol | MeOH | | | | | | | |
| | H₂ (BDC) | | | | | | | | |
| | 0.30 mmol | | | | | | | | |
| MOF-7 | Tb(NO₃)₃•5H₂O | H₂O | 102.3 | 91.12 | 101.5 | 6.142 | 10.069 | 10.096 | P-1 |
| | 0.15 mmol | | | | | | | | |
| | H₂(BDC) | | | | | | | | |
| | 0.15 mmol | | | | | | | | |
| MOF-69A | Zn(NO₃)₂•6H₂O | DEF | 90 | 111.6 | 90 | 23.12 | 20.92 | 12 | C2/c |
| | 0.083 mmol | H₂O₂ | | | | | | | |
| | 4,4′BPDC | MeNH₂ | | | | | | | |
| | 0.041 mmol | | | | | | | | |
| MOF-69B | Zn(NO₃)₂•6H₂O | DEF | 90 | 95.3 | 90 | 20.17 | 18.55 | 12.16 | C2/c |
| | 0.083 mmol | H₂O₂ | | | | | | | |
| | 2,6-NCD | MeNH₂ | | | | | | | |
| | 0.041 mmol | | | | | | | | |
| MOF-11 | Cu(NO₃)₂•2.5H₂O | H₂O | 90 | 93.86 | 90 | 12.987 | 11.22 | 11.336 | C2/c |
| Cu₂(ATC) | 0.47 mmol | | | | | | | | |
| | H₂ATC | | | | | | | | |
| | 0.22 mmol | | | | | | | | |
| MOF-11 | | | 90 | 90 | 90 | 8.4671 | 8.4671 | 14.44 | P42/ |
| Cu₂(ATC) | | | | | | | | | mmc |
| dehydr. | | | | | | | | | |
| MOF-14 | Cu(NO₃)₂•2.5H₂O | H₂O | 90 | 90 | 90 | 26.946 | 26.946 | 26.946 | Im-3 |
| Cu₃ (BTB) | 0.28 mmol | DMF | | | | | | | |
| | H₃BTB | EtOH | | | | | | | |
| | 0.052 mmol | | | | | | | | |
| MOF-32 | Cd(NO₃)₂•4H₂O | H₂O | 90 | 90 | 90 | 13.468 | 13.468 | 13.468 | P(−4) |
| Cd(ATC) | 0.24 mmol | NaOH | | | | | | | 3m |
| | H₄ATC | | | | | | | | |
| | 0.10 mmol | | | | | | | | |
| MOF-33 | ZnCl₂ | H₂O | 90 | 90 | 90 | 19.561 | 15.255 | 23.404 | Imma |
| Zn₂ (ATB) | 0.15 mmol | DMF | | | | | | | |
| | H₄ATB | EtOH | | | | | | | |
| | 0.02 mmol | | | | | | | | |
| MOF-34 | Ni(NO₃)₂•6H₂O | H₂O | 90 | 90 | 90 | 10.066 | 11.163 | 19.201 | P2₁2₁2₁ |
| Ni(ATC) | 0.24 mmol | NaOH | | | | | | | |
| | H₄ATC | | | | | | | | |
| | 0.10 mmol | | | | | | | | |
| MOF-36 | Zn(NO₃)₂•4H₂O | H₂O | 90 | 90 | 90 | 15.745 | 16.907 | 18.167 | Pbca |
| Zn₂ (MTB) | 0.20 mmol | DMF | | | | | | | |
| | H₄MTB | | | | | | | | |
| | 0.04 mmol | | | | | | | | |
| MOF-39 | Zn(NO₃)₂ 4H₂O | H₂O | 90 | 90 | 90 | 17.158 | 21.591 | 25.308 | Pnma |
| Zn₃O(HBTB) | 0.27 mmol | DMF | | | | | | | |
| | H₃BTB | EtOH | | | | | | | |
| | 0.07 mmol | | | | | | | | |
| NO305 | FeCl₂•4H₂O | DMF | 90 | 90 | 120 | 8.2692 | 8.2692 | 63.566 | R-3c |
| | 5.03 mmol | | | | | | | | |
| | formic acid | | | | | | | | |
| | 86.90 mmol | | | | | | | | |
| NO306A | FeCl₂•4H₂O | DEF | 90 | 90 | 90 | 9.9364 | 18.374 | 18.374 | Pbcn |
| | 5.03 mmol | | | | | | | | |
| | formic acid | | | | | | | | |
| | 86.90 mmol | | | | | | | | |
| NO29 | Mn(Ac)₂•4H₂O | DMF | 120 | 90 | 90 | 14.16 | 33.521 | 33.521 | P-1 |
| MOF-0 | 0.46 mmol | | | | | | | | |
| similar | H₃BTC | | | | | | | | |
| | 0.69 mmol | | | | | | | | |
| BPR48 | Zn(NO₃)₂ 6H₂O | DMSO | 90 | 90 | 90 | 14.5 | 17.04 | 18.02 | Pbca |
| A2 | 0.012 mmol | Toluene | | | | | | | |
| | H₂BDC | | | | | | | | |
| | 0.012 mmol | | | | | | | | |
| BPR69 | Cd(NO₃)₂ 4H₂O | DMSO | 90 | 98.76 | 90 | 14.16 | 15.72 | 17.66 | Cc |
| B1 | 0.0212 mmol | | | | | | | | |
| | H₂BDC | | | | | | | | |
| | 0.0428 mmol | | | | | | | | |
| BPR92 | Co(NO₃)₂•6H₂O | NMP | 106.3 | 107.63 | 107.2 | 7.5308 | 10.942 | 11.025 | P1 |
| A2 | 0.018 mmol | | | | | | | | |
| | H₂BDC | | | | | | | | |
| | 0.018 mmol | | | | | | | | |
| BPR95 | Cd(NO₃)₂ 4H₂O | NMP | 90 | 112.8 | 90 | 14.460 | 11.085 | 15.829 | P2(1)/n |
| C5 | 0.012 mmol | | | | | | | | |
| | H₂BDC | | | | | | | | |
| | 0.36 mmol | | | | | | | | |
| Cu C₆H₄O₆ | Cu(NO₃)₂•2.5H₂O | DMF | 90 | 105.29 | 90 | 15.259 | 14.816 | 14.13 | P2(1)/c |
| | 0.370 mmol | Chloro | | | | | | | |
| | H₂BDC(OH)₂ | benzene | | | | | | | |
| | 0.37 mmol | | | | | | | | |
| M(BTC) | Co(SO₄) H₂O | DMF | wie MOF-0 | | | | | | |
| MOF-0 | 0.055 mmol | | | | | | | | |
| similar | H₃BTC | | | | | | | | |
| | 0.037 mmol | | | | | | | | |
| Tb(C₆H₄O₆) | Tb(NO₃)₃•5H₂O | DMF | 104.6 | 107.9 | 97.147 | 10.491 | 10.981 | 12.541 | P-1 |
| | 0.370 mmol | Chloro- | | | | | | | |
| | H₂(C₆H₄O₆) | benzene | | | | | | | |
| | 0.56 mmol | | | | | | | | |
| Zn (C₂O₄) | ZnCl₂ | DMF | 90 | 120 | 90 | 9.4168 | 9.4168 | 8.464 | P(−3) |
| | 0.370 mmol | Chloro- | | | | | | | 1m |
| | oxalic acid | benzene | | | | | | | |
| | 0.37 mmol | | | | | | | | |
| Co(CHO) | Co(NO₃)₂•5H₂O | DMF | 90 | 91.32 | 90 | 11.328 | 10.049 | 14.854 | P2(1)/n |
| | 0.043 mmol | | | | | | | | |
| | formic acid | | | | | | | | |
| | 1.60 mmol | | | | | | | | |
| Cd(CHO) | Cd(NO₃)₂•4H₂O | DMF | 90 | 120 | 90 | 8.5168 | 8.5168 | 22.674 | R-3c |
| | 0.185 mmol | | | | | | | | |
| | formic acid | | | | | | | | |
| | 0.185 mmol | | | | | | | | |
| Cu(C₃H₂O₄) | Cu(NO₃)₂•2.5H₂O | DMF | 90 | 90 | 90 | 8.366 | 8.366 | 11.919 | P43 |
| | 0.043 mmol | | | | | | | | |
| | malonic acid | | | | | | | | |
| | 0.192 mmol | | | | | | | | |
| Zn₆ (NDC)₅ | Zn(NO₃)₂•6H₂O | DMF | 90 | 95.902 | 90 | 19.504 | 16.482 | 14.64 | C2/m |
| MOF-48 | 0.097 mmol | Chloro- | | | | | | | |
| | 14 NDC | benzene | | | | | | | |
| | 0.069 mmol | H₂O₂ | | | | | | | |
| MOF-47 | Zn(NO₃)₂ 6H₂O | DMF | 90 | 92.55 | 90 | 11.303 | 16.029 | 17.535 | P2(1)/c |
| | 0.185 mmol | Chloro- | | | | | | | |
| | H₂(BDC[CH₃]₄) | benzene | | | | | | | |
| | 0.185 mmol | H₂O₂ | | | | | | | |
| MO25 | Cu(NO₃)₂•2.5H₂O | DMF | 90 | 112.0 | 90 | 23.880 | 16.834 | 18.389 | P2(1)/c |
| | 0.084 mmol | | | | | | | | |
| | BPhDC | | | | | | | | |
| | 0.085 mmol | | | | | | | | |
| Cu-Thio | Cu(NO₃)₂•2.5H₂O | DEF | 90 | 113.6 | 90 | 15.4747 | 14.514 | 14.032 | P2(1)/c |
| | 0.084 mmol | | | | | | | | |
| | thiophene | | | | | | | | |
| | dicarboxylic acid | | | | | | | | |
| | 0.085 mmol | | | | | | | | |
| ClBDC1 | Cu(NO₃)₂•2.5H₂O | DMF | 90 | 105.6 | 90 | 14.911 | 15.622 | 18.413 | C2/c |
| | 0.084 mmol | | | | | | | | |
| | H₂(BDCCl₂) | | | | | | | | |
| | 0.085 mmol | | | | | | | | |
| MOF- | Cu(NO₃)₂•2.5H₂O | DMF | 90 | 90 | 90 | 21.607 | 20.607 | 20.073 | Fm3m |
| 101 | 0.084 mmol | | | | | | | | |
| | BrBDC | | | | | | | | |
| | 0.085 mmol | | | | | | | | |
| Zn₃(BTC)₂ | ZnCl₂ | DMF | 90 | 90 | 90 | 26.572 | 26.572 | 26.572 | Fm-3m |
| | 0.033 mmol | EtOH | | | | | | | |
| | H₃BTC | base | | | | | | | |
| | 0.033 mmol | present | | | | | | | |
| MOF-j | Co(CH₃CO₂)₂•4H₂O | H₂O | 90 | 112.0 | 90 | 17.482 | 12.963 | 6.559 | C2 |
| | (1.65 mmol) | | | | | | | | |
| | H₃(BZC) | | | | | | | | |
| | (0.95 mmol) | | | | | | | | |
| MOF-n | Zn(NO₃)₂•6H₂O | Ethanol | 90 | 90 | 120 | 16.711 | 16.711 | 14.189 | P6(3)/mcm |
| | H₃ (BTC) | | | | | | | | |
| PbBDC | Pb(NO₃)₂ | DMF | 90 | 102.7 | 90 | 8.3639 | 17.991 | 9.9617 | P2(1)/n |
| | (0.181 mmol) | Ethanol | | | | | | | |
| | H₂(BDC) | | | | | | | | |
| | (0.181 mmol) | | | | | | | | |
| Znhex | Zn(NO₃)₂•6H₂O | DMF | 90 | 90 | 120 | 37.1165 | 37.117 | 30.019 | P3(1)c |
| | (0.171 mmol) | p- | | | | | | | |
| | H₃BTB | Xylene | | | | | | | |
| | (0.114 mmol) | Ethanol | | | | | | | |
| AS16 | FeBr₂ | DMF | 90 | 90.13 | 90 | 7.2595 | 8.7894 | 19.484 | P2(1)c |
| | 0.927 mmol | anhydr. | | | | | | | |
| | H₂(BDC) | | | | | | | | |
| | 0.927 mmol | | | | | | | | |
| AS27-2 | FeBr₂ | DMF | 90 | 90 | 90 | 26.735 | 26.735 | 26.735 | Fm3m |
| | 0.927 mmol | anhydr. | | | | | | | |
| | H₃(BDC) | | | | | | | | |
| | 0.464 mmol | | | | | | | | |
| AS32 | FeCl₃ | DMF | 90 | 90 | 120 | 12.535 | 12.535 | 18.479 | P6(2)c |
| | 1.23 mmol | anhydr. | | | | | | | |
| | H₂(BDC) | Ethanol | | | | | | | |
| | 1.23 mmol | | | | | | | | |
| AS54-3 | FeBr₂ | DMF | 90 | 109.98 | 90 | 12.019 | 15.286 | 14.399 | C2 |
| | 0.927 | anhydr. | | | | | | | |
| | BPDC | n- | | | | | | | |
| | 0.927 mmol | Propanol | | | | | | | |
| AS61-4 | FeBr₂ | Pyridine | 90 | 90 | 120 | 13.017 | 13.017 | 14.896 | P6(2)c |
| | 0.927 mmol | anhydr. | | | | | | | |
| | m-BDC | | | | | | | | |
| | 0.927 mmol | | | | | | | | |
| AS68-7 | FeBr₂ | DMF | 90 | 90 | 90 | 18.3407 | 10.036 | 18.039 | Pca2₁ |
| | 0.927 mmol | anhydr. | | | | | | | |
| | m-BDC | Pyridine | | | | | | | |
| | 1.204 mmol | | | | | | | | |
| Zn(ADC) | Zn(NO₃)₂•6H₂O | DMF | 90 | 99.85 | 90 | 16.764 | 9.349 | 9.635 | C2/c |
| | 0.37 mmol | Chloro- | | | | | | | |
| | H₂(ADC) | benzene | | | | | | | |
| | 0.36 mmol | | | | | | | | |
| MOF-12 | Zn(NO₃)₂•6H₂O | Ethanol | 90 | 90 | 90 | 15.745 | 16.907 | 18.167 | Pbca |
| Zn₂ | 0.30 mmol | | | | | | | | |
| (ATC) | H₄(ATC) | | | | | | | | |
| | 0.15 mmol | | | | | | | | |
| MOF-20 | Zn(NO₃)₂•6H₂O | DMF | 90 | 92.13 | 90 | 8.13 | 16.444 | 12.807 | P2(1)/c |
| ZnNDC | 0.37 mmol | Chloro- | | | | | | | |
| | H₂NDC | benzene | | | | | | | |
| | 0.36 mmol | | | | | | | | |
| MOF-37 | Zn(NO₃)₂•6H₂O | DEF | 72.38 | 83.16 | 84.33 | 9.952 | 11.576 | 15.556 | P-1 |
| | 0.20 mmol | Chloro- | | | | | | | |
| | H₂NDC | benzene | | | | | | | |
| | 0.20 mmol | | | | | | | | |
| Zn(NDC) | Zn(NO₃)₂•6H₂O | DMSO | 68.08 | 75.33 | 88.31 | 8.631 | 10.207 | 13.114 | P-1 |
| (DMSO) | H₂NDC | | | | | | | | |
| Zn(NDC) | Zn(NO₃)₂•6H₂O | | 90 | 99.2 | 90 | 19.289 | 17.628 | 15.052 | C2/c |
| | H₂NDC | | | | | | | | |
| Zn(HPDC) | Zn(NO₃)₂•4H₂O | DMF | 107.9 | 105.06 | 94.4 | 8.326 | 12.085 | 13.767 | P-1 |
| | 0.23 mmol | H₂O | | | | | | | |
| | H₂(HPDC) | | | | | | | | |
| | 0.05 mmol | | | | | | | | |
| Co(HPDC) | Co(NO₃)₂•6H₂O | DMF | 90 | 97.69 | 90 | 29.677 | 9.63 | 7.981 | C2/c |
| | 0.21 mmol | H₂O/ | | | | | | | |
| | H₂ (HPDC) | Ethanol | | | | | | | |
| | 0.06 mmol | | | | | | | | |
| Zn₃(PDC) | Zn(NO₃)₂•4H₂O | DMF/ | 79.34 | 80.8 | 85.83 | 8.564 | 14.046 | 26.428 | P-1 |
| 2.5 | 0.17 mmol | ClBz | | | | | | | |
| | H₂(HPDC) | H₂0/ | | | | | | | |
| | 0.05 mmol | TEA | | | | | | | |
| Cd₂ | Cd(NO₃)₂•4H₂O | Methanol/ | 70.59 | 72.75 | 87.14 | 10.102 | 14.412 | 14.964 | P-1 |
| (TPDC)2 | 0.06 mmol | CHP | | | | | | | |
| | H₂(HPDC) | H₂O | | | | | | | |
| | 0.06 mmol | | | | | | | | |
| Tb(PDC) | Tb(NO₃)₃•5H₂O | DMF | 109.8 | 103.61 | 100.14 | 9.829 | 12.11 | 14.628 | P-1 |
| 1.5 | 0.21 mmol | H₂O/ | | | | | | | |
| | H₂(PDC) | Ethanol | | | | | | | |
| | 0.034 mmol | | | | | | | | |
| ZnDBP | Zn(NO₃)₂•6H₂O | MeOH | 90 | 93.67 | 90 | 9.254 | 10.762 | 27.93 | P2/n |
| | 0.05 mmol | | | | | | | | |
| | dibenzyl | | | | | | | | |
| | phosphate | | | | | | | | |
| | 0.10 mmol | | | | | | | | |
| Zn₃(BPDC) | ZnBr₂ | DMF | 90 | 102.76 | 90 | 11.49 | 14.79 | 19.18 | P21/n |
| | 0.021 mmol | | | | | | | | |
| | 4,4′BPDC | | | | | | | | |
| | 0.005 mmol | | | | | | | | |
| CdBDC | Cd(NO₃)₂•4H₂O | DMF | 90 | 95.85 | 90 | 11.2 | 11.11 | 16.71 | P21/n |
| | 0.100 mmol | Na₂SiO₃ | | | | | | | |
| | H₂(BDC) | (aq) | | | | | | | |
| | 0.401 mmol | | | | | | | | |
| Cd- | Cd(NO₃)₂•4H₂O | DMF | 90 | 101.1 | 90 | 13.69 | 18.25 | 14.91 | C2/c |
| mBDC | 0.009 mmol | MeNH₂ | | | | | | | |
| | H₂(mBDC) | | | | | | | | |
| | 0.018 mmol | | | | | | | | |
| Zn₄OBNDC | Zn(NO₃)₂•6H₂O | DEF | 90 | 90 | 90 | 22.35 | 26.05 | 59.56 | Fmmm |
| | 0.041 mmol | MeNH₂ | | | | | | | |
| | BNDC | H₂O₂ | | | | | | | |
| Eu(TCA) | Eu(NO₃)₃•6H₂O | DMF | 90 | 90 | 90 | 23.325 | 23.325 | 23.325 | Pm-3n |
| | 0.14 mmol | Chloro- | | | | | | | |
| | TCA | benzene | | | | | | | |
| | 0.026 mmol | | | | | | | | |
| Tb(TCA) | Tb(NO₃)₃•6H₂O | DMF | 90 | 90 | 90 | 23.272 | 23.272 | 23.372 | Pm-3n |
| | 0.069 mmol | Chloro- | | | | | | | |
| | TCA | benzene | | | | | | | |
| | 0.026 mmol | | | | | | | | |
| Formates | Ce(NO₃)₃•6H₂O | H₂O | 90 | 90 | 120 | 10.668 | 10.667 | 4.107 | R-3m |
| | 0.138 mmol | Ethanol | | | | | | | |
| | formic acid | | | | | | | | |
| | 0.43 mmol | | | | | | | | |
| | FeCl₂•4H₂O | DMF | 90 | 90 | 120 | 8.2692 | 8.2692 | 63.566 | R-3c |
| | 5.03 mmol | | | | | | | | |
| | formic acid | | | | | | | | |
| | 86.90 mmol | | | | | | | | |
| | FeCl₂•4H₂O | DEF | 90 | 90 | 90 | 9.9364 | 18.374 | 18.374 | Pbcn |
| | 5.03 mmol | | | | | | | | |
| | formic acid | | | | | | | | |
| | 86.90 mmol | | | | | | | | |
| | FeCl₂•4H₂O | DEF | 90 | 90 | 90 | 8.335 | 8.335 | 13.34 | P-31c |
| | 5.03 mmol | | | | | | | | |
| | formic acid | | | | | | | | |
| | 86.90 mmol | | | | | | | | |
| NO330 | FeCl₂•4H₂O | Formamide | 90 | 90 | 90 | 8.7749 | 11.655 | 8.3297 | Pnna |
| | 0.50 mmol | | | | | | | | |
| | formic acid | | | | | | | | |
| | 8.69 mmol | | | | | | | | |
| NO332 | FeCl₂•4H₂O | DIP | 90 | 90 | 90 | 10.0313 | 18.808 | 18.355 | Pbcn |
| | 0.50 mmol | | | | | | | | |
| | formic acid | | | | | | | | |
| | 8.69 mmol | | | | | | | | |
| NO333 | FeCl₂•4H₂O | DBF | 90 | 90 | 90 | 45.2754 | 23.861 | 12.441 | Cmcm |
| | 0.50 mmol | | | | | | | | |
| | formic acid | | | | | | | | |
| | 8.69 mmol | | | | | | | | |
| NO335 | FeCl₂•4H₂O | CHF | 90 | 91.372 | 90 | 11.5964 | 10.187 | 14.945 | P21/n |
| | 0.50 mmol | | | | | | | | |
| | formic acid | | | | | | | | |
| | 8.69 mmol | | | | | | | | |
| NO336 | FeCl₂•4H₂O | MFA | 90 | 90 | 90 | 11.7945 | 48.843 | 8.4136 | Pbcm |
| | 0.50 mmol | | | | | | | | |
| | formic acid | | | | | | | | |
| | 8.69 mmol | | | | | | | | |
| NO13 | Mn(Ac)₂•4H₂O | Ethanol | 90 | 90 | 90 | 18.66 | 11.762 | 9.418 | Pbcn |
| | 0.46 mmol | | | | | | | | |
| | benzoic acid | | | | | | | | |
| | 0.92 mmol | | | | | | | | |
| | bipyridine | | | | | | | | |
| | 0.46 mmol | | | | | | | | |
| NO29 | Mn(Ac)₂•4H₂O | DMF | 120 | 90 | 90 | 14.16 | 33.521 | 33.521 | P-1 |
| MOF-0 | 0.46 mmol | | | | | | | | |
| similar | H₃BTC | | | | | | | | |
| | 0.69 mmol | | | | | | | | |
| Mn(hfac)₂ | Mn(Ac)₂•4H₂O | Ether | 90 | 95.32 | 90 | 9.572 | 17.162 | 14.041 | C2/c |
| (O₂CC₆H₅) | 0.46 mmol | | | | | | | | |
| | Hfac | | | | | | | | |
| | 0.92 mmol | | | | | | | | |
| | bipyridine | | | | | | | | |
| | 0.46 mmol | | | | | | | | |
| BPR43G2 | Zn(NO₃)₂•6H₂O | DMF | 90 | 91.37 | 90 | 17.96 | 6.38 | 7.19 | C2/c |
| | 0.0288 mmol | CH₃CN | | | | | | | |
| | H₂BDC | | | | | | | | |
| | 0.0072 mmol | | | | | | | | |
| BPR48A2 | Zn(NO₃)₂ 6H₂O | DMSO | 90 | 90 | 90 | 14.5 | 17.04 | 18.02 | Pbca |
| | 0.012 mmol | Toluene | | | | | | | |
| | H₂BDC | | | | | | | | |
| | 0.012 mmol | | | | | | | | |
| BPR49B1 | Zn(NO₃)₂ 6H₂O | DMSO | 90 | 91.172 | 90 | 33.181 | 9.824 | 17.884 | C2/c |
| | 0.024 mmol | Methanol | | | | | | | |
| | H₂BDC | | | | | | | | |
| | 0.048 mmol | | | | | | | | |
| BPR56E1 | Zn(NO₃)₂ 6H₂O | DMSO | 90 | 90.096 | 90 | 14.5873 | 14.153 | 17.183 | P2(1)/n |
| | 0.012 mmol | n- | | | | | | | |
| | H₂BDC | Propanol | | | | | | | |
| | 0.024 mmol | | | | | | | | |
| BPR68D10 | Zn(NO₃)₂ 6H₂O | DMSO | 90 | 95.316 | 90 | 10.0627 | 10.17 | 16.413 | P2(1)/c |
| | 0.0016 mmol | Benzene | | | | | | | |
| | H₃BTC | | | | | | | | |
| | 0.0064 mmol | | | | | | | | |
| BPR69B1 | Cd(NO₃)₂ 4H₂O | DMSO | 90 | 98.76 | 90 | 14.16 | 15.72 | 17.66 | Cc |
| | 0.0212 mmol | | | | | | | | |
| | H₂BDC | | | | | | | | |
| | 0.0428 mmol | | | | | | | | |
| BPR73E4 | Cd(NO₃)₂ | DMSO | 90 | 92.324 | 90 | 8.7231 | 7.0568 | 18.438 | P2(1)/n |
| | 4H₂O | Toluene | | | | | | | |
| | 0.006 mmol | | | | | | | | |
| | H₂BDC | | | | | | | | |
| | 0.003 mmol | | | | | | | | |
| BPR76D5 | Zn(NO₃)₂ 6H₂O | DMSO | 90 | 104.17 | 90 | 14.4191 | 6.2599 | 7.0611 | Pc |
| | 0.0009 mmol | | | | | | | | |
| | H₂BzPDC | | | | | | | | |
| | 0.0036 mmol | | | | | | | | |
| BPR80B5 | Cd(NO₃)₂•4H₂O | DMF | 90 | 115.11 | 90 | 28.049 | 9.184 | 17.837 | C2/c |
| | 0.018 mmol | | | | | | | | |
| | H₂BDC | | | | | | | | |
| | 0.036 mmol | | | | | | | | |
| BPR80H5 | Cd(NO₃)₂ | DMF | 90 | 119.06 | 90 | 11.4746 | 6.2151 | 17.268 | P2/c |
| | 4H₂O | | | | | | | | |
| | 0.027 mmol | | | | | | | | |
| | H₂BDC | | | | | | | | |
| | 0.027 mmol | | | | | | | | |
| BPR82C6 | Cd(NO₃)₂ | DMF | 90 | 90 | 90 | 9.7721 | 21.142 | 27.77 | Fdd2 |
| | 4H₂O | | | | | | | | |
| | 0.0068 mmol | | | | | | | | |
| | H₂BDC | | | | | | | | |
| | 0.202 mmol | | | | | | | | |
| BPR86C3 | Co(NO₃)₂ | DMF | 90 | 90 | 90 | 18.3449 | 10.031 | 17.983 | Pca2(1) |
| | 6H₂O | | | | | | | | |
| | 0.0025 mmol | | | | | | | | |
| | H₂BDC | | | | | | | | |
| | 0.075 mmol | | | | | | | | |
| BPR86H6 | Cd(NO₃)₂•6H₂O | DMF | 80.98 | 89.69 | 83.412 | 9.8752 | 10.263 | 15.362 | P-1 |
| | 0.010 mmol | | | | | | | | |
| | H₂BDC | | | | | | | | |
| | 0.010 mmol | | | | | | | | |
| | Co(NO₃)₂ | NMP | 106.3 | 107.63 | 107.2 | 7.5308 | 10.942 | 11.025 | P1 |
| | 6H₂O | | | | | | | | |
| BPR95A2 | Zn(NO₃)₂ 6H₂O | NMP | 90 | 102.9 | 90 | 7.4502 | 13.767 | 12.713 | P2(1)/c |
| | 0.012 mmol | | | | | | | | |
| | H₂BDC | | | | | | | | |
| | 0.012 mmol | | | | | | | | |
| CuC₆F₄O₄ | Cu(NO₃)₂•2.5H₂O | DMF | 90 | 98.834 | 90 | 10.9675 | 24.43 | 22.553 | P2(1)/n |
| | 0.370 mmol | Chloro- | | | | | | | |
| | H₂BDC(OH)₂ | benzene | | | | | | | |
| | 0.37 mmol | | | | | | | | |
| Fe Formic | FeCl₂•4H₂O | DMF | 90 | 91.543 | 90 | 11.495 | 9.963 | 14.48 | P2(1)/n |
| | 0.370 mmol | | | | | | | | |
| | formic acid | | | | | | | | |
| | 0.37 mmol | | | | | | | | |
| Mg Formic | Mg(NO₃)₂•6H₂O | DMF | 90 | 91.359 | 90 | 11.383 | 9.932 | 14.656 | P2(1)/n |
| | 0.370 mmol | | | | | | | | |
| | formic acid | | | | | | | | |
| | 0.37 mmol | | | | | | | | |
| MgC₆H₄O₆ | Mg(NO₃)₂•6H₂O | DMF | 90 | 96.624 | 90 | 17.245 | 9.943 | 9.273 | C2/c |
| | 0.370 mmol | | | | | | | | |
| | H₂BDC(OH)₂ | | | | | | | | |
| | 0.37 mmol | | | | | | | | |
| Zn | ZnCl₂ | DMF | 90 | 94.714 | 90 | 7.3386 | 16.834 | 12.52 | P2(1)/n |
| C₂H₄BDC | 0.44 mmol | | | | | | | | |
| MOF-38 | CBBDC | | | | | | | | |
| | 0.261 mmol | | | | | | | | |
| MOF-49 | ZnCl₂ | DMF | 90 | 93.459 | 90 | 13.509 | 11.984 | 27.039 | P2/c |
| | 0.44 mmol | CH₃CN | | | | | | | |
| | m-BDC | | | | | | | | |
| | 0.261 mmol | | | | | | | | |
| MOF-26 | Cu(NO₃)₂•5H₂O | DMF | 90 | 95.607 | 90 | 20.8797 | 16.017 | 26.176 | P2(1)/n |
| | 0.084 mmol | | | | | | | | |
| | DCPE | | | | | | | | |
| | 0.085 mmol | | | | | | | | |
| MOF-112 | Cu(NO₃)₂•2.5H₂O | DMF | 90 | 107.49 | 90 | 29.3241 | 21.297 | 18.069 | C2/c |
| | 0.084 mmol | Ethanol | | | | | | | |
| | o-Br-m-BDC | | | | | | | | |
| | 0.085 mmol | | | | | | | | |
| MOF-109 | Cu(NO₃)₂•2.5H₂O | DMF | 90 | 111.98 | 90 | 23.8801 | 16.834 | 18.389 | P2(1)/c |
| | 0.084 mmol | | | | | | | | |
| | KDB | | | | | | | | |
| | 0.085 mmol | | | | | | | | |
| MOF-111 | Cu(NO₃)₂•2.5H₂O | DMF | 90 | 102.16 | 90 | 10.6767 | 18.781 | 21.052 | C2/c |
| | 0.084 mmol | Ethanol | | | | | | | |
| | o-BrBDC | | | | | | | | |
| | 0.085 mmol | | | | | | | | |
| MOF-110 | Cu(NO₃)₂•2.5H₂O | DMF | 90 | 90 | 120 | 20.0652 | 20.065 | 20.747 | R-3/m |
| | 0.084 mmol | | | | | | | | |
| | thiophene | | | | | | | | |
| | dicarboxylic | | | | | | | | |
| | acid | | | | | | | | |
| | 0.085 mmol | | | | | | | | |
| MOF-107 | Cu(NO₃)₂•2.5H₂O | DEF | 104.8 | 97.075 | 95.206 | 11.032 | 18.067 | 18.452 | P-1 |
| | 0.084 mmol | | | | | | | | |
| | thiophene | | | | | | | | |
| | dicarboxylic | | | | | | | | |
| | acid | | | | | | | | |
| | 0.085 mmol | | | | | | | | |
| MOF-108 | Cu(NO₃)₂•2.5H₂O | DBF/ | 90 | 113.63 | 90 | 15.4747 | 14.514 | 14.032 | C2/c |
| | 0.084 mmol | Methanol | | | | | | | |
| | thiophene | | | | | | | | |
| | dicarboxylic | | | | | | | | |
| | acid | | | | | | | | |
| | 0.085 mmol | | | | | | | | |
| MOF-102 | Cu(NO₃)₂•2.5H₂O | DMF | 91.63 | 106.24 | 112.01 | 9.3845 | 10.794 | 10.831 | P-1 |
| | 0.084 mmol | | | | | | | | |
| | H₂(BDCCl₂) | | | | | | | | |
| | 0.085 mmol | | | | | | | | |
| Clbdc1 | Cu(NO₃)₂•2.5H₂O | DEF | 90 | 105.56 | 90 | 14.911 | 15.622 | 18.413 | P-1 |
| | 0.084 mmol | | | | | | | | |
| | H₂(BDCCl₂) | | | | | | | | |
| | 0.085 mmol | | | | | | | | |
| Cu(NMOP) | Cu(NO₃)₂•2.5H₂O | DMF | 90 | 102.37 | 90 | 14.9238 | 18.727 | 15.529 | P2(1)/m |
| | 0.084 mmol | | | | | | | | |
| | NBDC | | | | | | | | |
| | 0.085 mmol | | | | | | | | |
| Tb(BTC) | Tb(NO₃)₃•5H₂O | DMF | 90 | 106.02 | 90 | 18.6986 | 11.368 | 19.721 | |
| | 0.033 mmol | | | | | | | | |
| | H₃BTC | | | | | | | | |
| | 0.033 mmol | | | | | | | | |
| Zn₃(BTC)₂ | ZnCl₂ | DMF | 90 | 90 | 90 | 26.572 | 26.572 | 26.572 | Fm-3m |
| Honk | 0.033 mmol | Ethanol | | | | | | | |
| | H₃BTC | | | | | | | | |
| | 0.033 mmol | | | | | | | | |
| Zn₄O(NDC) | Zn(NO₃)₂•4H₂O | DMF | 90 | 90 | 90 | 41.5594 | 18.818 | 17.574 | aba2 |
| | 0.066 mmol | Ethanol | | | | | | | |
| | 14NDC | | | | | | | | |
| | 0.066 mmol | | | | | | | | |
| CdTDC | Cd(NO₃)₂•4H₂O | DMF | 90 | 90 | 90 | 12.173 | 10.485 | 7.33 | Pmma |
| | 0.014 mmol | H₂O | | | | | | | |
| | thiophene | | | | | | | | |
| | 0.040 mmol | | | | | | | | |
| | DABCO | | | | | | | | |
| | 0.020 mmol | | | | | | | | |
| IRMOF-2 | Zn(NO₃)₂•4H₂O | DEF | 90 | 90 | 90 | 25.772 | 25.772 | 25.772 | Fm-3m |
| | 0.160 mmol | | | | | | | | |
| | o-Br-BDC | | | | | | | | |
| | 0.60 mmol | | | | | | | | |
| IRMOF-3 | Zn(NO₃)₂•4H₂O | DEF | 90 | 90 | 90 | 25.747 | 25.747 | 25.747 | Fm-3m |
| | 0.20 mmol | Ethanol | | | | | | | |
| | H₂N-BDC | | | | | | | | |
| | 0.60 mmol | | | | | | | | |
| IRMOF-4 | Zn(NO₃)₂•4H₂O | DEF | 90 | 90 | 90 | 25.849 | 25.849 | 25.849 | Fm-3m |
| | 0.11 mmol | | | | | | | | |
| | [C₃H₇O]₂-BDC | | | | | | | | |
| | 0.48 mmol | | | | | | | | |
| IRMOF-5 | Zn(NO₃)₂•4H₂O | DEF | 90 | 90 | 90 | 12.882 | 12.882 | 12.882 | Pm-3m |
| | 0.13 mmol | | | | | | | | |
| | [C₅H₁₁O]₂-BDC | | | | | | | | |
| | 0.50 mmol | | | | | | | | |
| IRMOF-6 | Zn(NO₃)₂•4H₂O | DEF | 90 | 90 | 90 | 25.842 | 25.842 | 25.842 | Fm-3m |
| | 0.20 mmol | | | | | | | | |
| | [C₂H₄]-BDC | | | | | | | | |
| | 0.60 mmol | | | | | | | | |
| IRMOF-7 | Zn(NO₃)₂•4H₂O | DEF | 90 | 90 | 90 | 12.914 | 12.914 | 12.914 | Pm-3m |
| | 0.07 mmol | | | | | | | | |
| | 1,4NDC | | | | | | | | |
| | 0.20 mmol | | | | | | | | |
| IRMOF-8 | Zn(NO₃)₂•4H₂O | DEF | 90 | 90 | 90 | 30.092 | 30.092 | 30.092 | Fm-3m |
| | 0.55 mmol | | | | | | | | |
| | 2,6NDC | | | | | | | | |
| | 0.42 mmol | | | | | | | | |
| IRMOF-9 | Zn(NO₃)₂•4H₂O | DEF | 90 | 90 | 90 | 17.147 | 23.322 | 25.255 | Pnnm |
| | 0.05 mmol | | | | | | | | |
| | BPDC | | | | | | | | |
| | 0.42 mmol | | | | | | | | |
| IRMOF-10 | Zn(NO₃)₂•4H₂O | DEF | 90 | 90 | 90 | 34.281 | 34.281 | 34.281 | Fm-3m |
| | 0.02 mmol | | | | | | | | |
| | BPDC | | | | | | | | |
| | 0.012 mmol | | | | | | | | |
| IRMOF-11 | Zn(NO₃)₂•4H₂O | DEF | 90 | 90 | 90 | 24.822 | 24.822 | 56.734 | R-3m |
| | 0.05 mmol | | | | | | | | |
| | HPDC | | | | | | | | |
| | 0.20 mmol | | | | | | | | |
| IRMOF-12 | Zn(NO₃)₂•4H₂O | DEF | 90 | 90 | 90 | 34.281 | 34.281 | 34.281 | Fm-3m |
| | 0.017 mmol | | | | | | | | |
| | HPDC | | | | | | | | |
| | 0.12 mmol | | | | | | | | |
| IRMOF- | Zn(NO₃)₂•4H₂O | DEF | 90 | 90 | 90 | 24.822 | 24.822 | 56.734 | R-3m |
| 13 | 0.048 mmol | | | | | | | | |
| | PDC | | | | | | | | |
| | 0.31 mmol | | | | | | | | |
| IRMOF- | Zn(NO₃)₂•4H₂O | DEF | 90 | 90 | 90 | 34.381 | 34.381 | 34.381 | Fm-3m |
| 14 | 0.17 mmol | | | | | | | | |
| | PDC | | | | | | | | |
| | 0.12 mmol | | | | | | | | |
| IRMOF- | Zn(NO₃)₂•4H₂O | DEF | 90 | 90 | 90 | 21.459 | 21.459 | 21.459 | Im-3m |
| 15 | 0.063 mmol | | | | | | | | |
| | TPDC | | | | | | | | |
| | 0.025 mmol | | | | | | | | |
| IRMOF- | Zn(NO₃)₂•4H₂O | DEF | 90 | 90 | 90 | 21.49 | 21.49 | 21.49 | Pm-3m |
| 16 | 0.0126 mmol | NMP | | | | | | | |
| | TPDC | | | | | | | | |
| | 0.05 mmol | | | | | | | | |

ADC Acetylenedicarboxylic acid
NDC Naphthalenedicarboxylic acid
BDC Benzenedicarboxylic acid
ATC Adamantanetetracarboxylic acid
BTC Benzenetricarboxylic acid
BTB Benzenetribenzoic acid
MTB Methanetetrabenzoic acid
ATB Adamantanetetrabenzoic acid
ADB Adamantanedibenzoic acid

Further MOFs are MOF-177, MOF-178, MOF-74, MOF-235, MOF-236, MOF-69 to 80, MOF-501, MOF-502, which are described in the literature.

In particular preference is given to a porous metal-organic framework material in which Zn or Cu is present as metal ion and the at least bidentate organic compound is terephthalic acid, isophthalic acid, 2,6-naphthalenedicarboxylic acid or 1,3,5-benzenetricarboxylic acid.

In addition to the conventional method for producing the MOFs, as is described, for example, in U.S. Pat. No. 5,648,508, they can also be produced in an electrochemical manner. In this respect, reference is made to DE-A 103 55 087 and also WO-A 2005/049892. The MOFs produced in this manner exhibit particularly good properties in connection with the adsorption and desorption of chemical substances, in particular gases. In this way they are differentiated from those which are produced conventionally, even when they are formed from the same organic and metal-ion constituents, and are therefore to be considered novel framework materials. In the context of the present invention, electrochemically produced MOFs are particularly preferred.

Accordingly, the electrochemical production relates to a crystalline porous metal-organic framework material comprising at least one, at least bidentate, organic compound bound by coordination to at least one metal ion, which at least one metal ion is produced in a reaction medium comprising the at least one bidentate organic compound by oxidation of at least one anode comprising the corresponding metal.

The term “electrochemical production” designates a production method in which the formation of at least one reaction product is associated with the migration of electric charges or the occurrence of electric potentials.

The term “at least one metal ion”, as used in connection with the electrochemical production, designates embodiments according to which at least one ion of a metal or at least one ion of a first metal and at least one ion of at least one second metal different from the first metal are provided by anodic oxidation.

Accordingly, the electrochemical production relates to embodiments in which at least one ion of at least one metal is provided by anodic oxidation and at least one ion of at least one metal is provided by a metal salt, the at least one metal in the metal salt and the at least one metal which is provided as metal ion via anodic oxidation being able to be identical or different from one another. Therefore, the present invention, in relation to electrochemically produced MOFs comprises, for example, an embodiment according to which the reaction medium comprises one or more different salts of a metal and the metal ion present in this salt or in these salts is additionally provided by anodic oxidation of at least one anode comprising this metal. Likewise, the reaction medium can comprise one or more different salts of at least one metal and at least one metal different from these metals can be provided via anodic oxidation of metal ion in the reaction medium.

According to a preferred embodiment of the present invention in connection with the electrochemical production, the at least one metal ion is provided by anodic oxidation of at least one anode comprising this at least one metal, no further metal being provided via a metal salt.

The term “metal”, as used in the context of the present invention in connection with the electrochemical production of MOFs, comprises all elements of the Periodic Table of the Elements which can be provided via anodic oxidation in the electrochemical method in a reaction medium and are able with at least one at least bidentate organic compounds to form at least one metal-organic porous framework material.

Independently of its production, the resultant MOF is produced in powder or crystalline form. This can be used as such as sorbent in the inventive method alone or together with other sorbents or other materials. Preferably, this takes place as bulk material, in particular in a fixed bed. In addition, the MOF can be converted into a shaped body. Preferred methods in this case are rod-extrusion or tableting. In shaped body production, further materials, for example binders, lubricants or other additives can be added to the MOF. It is likewise conceivable that mixtures of MOF and other adsorbents, for example activated carbon, are produced as shaped bodies or separately give shaped bodies which are then used as shaped body mixtures.

With respect to the possible geometries of these MOF shaped bodies, there exist essentially no restrictions. For example, inter alia pellets, for example disc-shaped pellets, pills, spheres, granules, extrudates, for example rods, honeycombs, meshes or hollow bodies may be mentioned.

For production of these shaped bodies, in principle all suitable methods are possible. In particular, the following procedures are preferred:
Kneading the framework material alone or together with at least one binder and/or at least one pasting aid and/or at least one template compound to obtain a mixture; shaping the resultant mixture by means of at least one suitable method for example extrusion; optionally washing and/or drying and/or calcining the extrudate; optionally final processing.
Applying the framework material to at least one if appropriate porous support material. The resultant material can then be further processed in accordance with the above described method to give a shaped body.
Applying the framework material to at least one if appropriate porous substrate.
Foaming to form porous plastics, for example polyurethane.

Kneading and shaping can be performed in accordance with any suitable method, for example as described in Ullmanns Enzykiopädie der Technischen Chemie [Ulmann's Encyclopedia of Industrial Chemistry], 4th Edition, Volume 2, pp. 313ff. (1972), the contents of which in this respect are incorporated in their entirety by reference into the context of the present application.

For example, preferably, the kneading and/or shaping can be performed by means of a piston press, roller press in the presence or absence of at least one binder, compounding, pelleting, tableting, extrusion, co-extrusion, foaming, spinning, coating, granulating, preferably spray-granulating, spraying, spray-drying or a combination of two or more of these methods.

Very particularly, pellets and/or tablets are produced.

The kneading and/or shaping can be performed at elevated temperatures, for example in the range from room temperature to 300° C. and/or at elevated pressure, for example in the range from atmospheric pressure up to several hundred bar and/or in a protective gas atmosphere, for example in the presence of at least one noble gas, nitrogen or a mixture of two or more thereof.

The kneading and/or shaping is carried out according to a further embodiment with addition of at least one binder, in which, as binder, in principle use can be made of any chemical compound which ensures the viscosity desired for kneading and/or shaping of the mass to be kneaded and/or shaped. Accordingly, binders in the context of the present invention can be not only viscosity-increasing compounds, but also viscosity-decreasing compounds.

As inter alia preferred binders, mention may be made of, for example, aluminum oxide, or binders comprising aluminum oxide, as are described, for example, in WO 94/29408, silicon dioxide, as described, for example, in EP 0 592 050 A1, mixtures of silicon dioxide and aluminum oxide, as are described, for example, in WO 94/13584, clay minerals, as are described, for example, in JP 03-037156 A, for example montmorillonite, kaolin, bentonite, hallosite, dickite, nacrite and anauxite, alkoxysilanes, as are described, for example, in EP 0 102 544 B1, for example tetraalkoxysilanes, for example tetramethoxysilane, tetraethoxysilane, tetrapropoxysilane, tetrabutoxysilane, or, for example, trialkoxysilanes, for example trimethoxysilane, triethoxysilane, tripropoxysilane, tributoxysilane, alkoxytitanates, for example tetraalkoxytitanates, for example tetramethoxytitanate, tetraethoxytitanate, tetrapropoxytitanate, tetrabutoxytitanate, or, for example, trialkoxytitanates, for example trimethoxytitanate, triethoxytitanate, tripropoxytitanate, tributoxytitanate, alkoxyzirconates, for example tetraalkoxyzirconates, for example tetramethoxyzirconate, tetraethoxyzirconate, tetrapropoxyzirconate, tetrabutoxyzirconate, or, for example, trialkoxyzirconates, for example trimethoxyzirconate, triethoxyzirconate, tripropoxyzirconate, tributoxyzirconate, silica sols, amphiphilic substances and/or graphites. In particular preference is given to graphite.

As viscosity-increasing compound, use can also be made of, for example, if appropriate in addition to the abovementioned compounds, an organic compound and/or a hydrophilic polymer, for example cellulose or a cellulose derivative, for example methylcellulose and/or a polyacrylate and/or a polymethacrylate and/or a poly(vinyl alcohol) and/or polyvinylpyrrolidone and/or a polyisobutene and/or a polytetrahydrofuran.

As pasting aid, use can preferably be made, inter alia, of water or at least one alcohol, for example a monohydric alcohol having 1 to 4 carbon atoms, for example methanol, ethanol, n-propanol, isopropanol, 1-butanol, 2-butanol, 2-methyl-1-propanol, or 2-methyl-2propanol, or a mixture of water and at least one of said alcohols or one polyhydric alcohol, for example a glycol, preferably a water-miscible polyhydric alcohol, alone or as a mixture with water and/or at least one of said monohydric alcohols.

Further additives which can be used for the kneading and/or shaping are, inter alia, amines or amine derivatives, for example tetraalkylammonium compounds or amino alcohols and carbonate-comprising compounds, such as calcium carbonate. Such further additives are described, for instance, in EP 0 389 041 A1, EP 0 200 260 A1, or WO 95/19222.

The sequence of the additives such as template compound, binder, pasting aid, viscosity-increasing substance, on shaping and kneading is not critical in principle.

According to a further preferred embodiment, the shaped body obtained according to kneading and/or shaping is subjected to at least one drying, which is generally carried out at a temperature in the range from 25 to 300° C., preferably in the range from 50 to 300° C., and particularly preferably in the range from 100 to 300° C. It is likewise possible to carry out drying in vacuum or under a protecting gas atmosphere or by spray drying.

According to a particularly preferred embodiment, in the context of this drying operation, at least one of the compounds added as additive is at least partially removed from the shaped body.

The invention further relates to the use of a porous metal-organic framework material, the framework material comprising at least one, at least bidentate, organic compound bound by coordination to at least one metal ion, for separating off odor substances from gases.

Provided that the odor substances separated off in the filter by the metal-organic framework material are organic compounds, these can further, using electrical discharge, be, preferably completely, decomposed to inorganic compounds. In this case, the filter can be integrated into a high-voltage unit, or the unit itself forms the filter.

### EXAMPLES

### Example 1

### Odor Reduction by Metal-Organic Framework Materials Comprising Zinc

Samples tested: MOF-5 (Zn-MOF based on terephthalic acid)
IRMOF-8 (Zn-MOF based on naphthalenedicarboxylic acid)

In each case 2 g of MOF-5 and IRMOF-8 are placed into home-made “teabags” (size approximately 5×6 cm) made of filter paper. These hang freely in 500 ml wide-neck flasks. Into the flasks are placed a defined number of droplets of the test substance, without the droplets coming into contact with the bag, then the flasks are closed. After about one hour of exposure time, the gas content in the flask is tested by means of Dräger tubes (Drägerwerk AG, Lübeck, Germany).

In the case of ammonia, the odor was tested by olfactory means.

| | Number | Dräger tube plus | Number | Dräger indication [ppm] | | |
|---|---|---|---|---|---|---|
| Test | of | measurement | of | Without | | |
| substance | droplets | range | strokes | MOF | MOF-5 | IRMOF-8 |
| Ammonia | 2 | — | — | Very strongly | No NH₃ odor | |
| (25%) | | | | of NH₃ | | |
| Test petroleum | 8 | 10/a | 2 | 25 | <10 | <10 |
| (155-185° C.) | | (10-300 ppm) | | | | |

As can be seen from the table, a marked reduction in the concentration of the test substances in the ambient air may be perceived or established.

### Example 2

### According to the Invention

A tubular reactor having internal diameter 10 mm is charged with 10 g of the MOF material which has been pressed and then splintered in advance (particle size distribution between 1 to 2 mm screen fraction) and charged at 25° C. with a gas mixture in straight through-flow passage.

The MOF material is an electrochemically produced Cu-MOF material. The production is described in Example 2 of WO-A 2005/049892.

The gas mixture comprises methane at a loading of 6250 L_{gas}/L_{MOF}/h and is admixed with 13 ppmᵥ of tetrahydrothiophene (THT) as odorant.

In the exit of the reactor, the exiting gas is analyzed by a gas chromatograph (flame ionization detector). The analysis of sulfur compounds is operated in the same manner using a flame photometer. After termination of the experiment, the sample material is removed and the sulfur content determined by means of methods of organic element analysis (see “Quantitative Organische Elementaranalyse” [Quantitative Organic Elemental Analysis], Ehrenberger, VCH Verlagsgesellschaft, Weinheim, 1991, pp. 242 ff.).

The absorption capacity of the MOF material up to occurrence of values greater than 2 ppm of THT in the break-through curve is determined at 70 g of THT/L_{MOF}.

### Example 3 (Comparative Example)

In a similar manner to Example 2, 10 g of activated carbon (from Norit, type RB4) are used. After carrying out the experiment, the absorption capacity of sulfur on the activated carbon is determined at 0.5 g of THT/g of activated carbon.

### Example 4 (Comparative Example)

In a similar manner to Example 2, 10 g of activated carbon (CarboTech, type C38/4) are used. After carrying out the experiment, the adsorption capacity of sulfur on the activated carbon is determined at 6.5 g of THT/g of activated carbon.

### Example 5

### Temperature-Programmed Desorption

To determine the sorption capacity of metal-organic framework materials in relation to odor substances, the peak maximum temperature (T_{PM}) is determined by temperature-programmed desorption. For this, use is made of the instrument AutoChem II 2920 V3.00 from Micromeritics GmbH (Mönchengladbach, Germany).

In this case, first the framework material is saturated with the odor substance at 40° C. and the temperature is then elevated to 300° C. (gradient 10 K/min). The maximum is determined using the heat conductivity signal.

The framework materials are Zn MOF-5 (MOF A) and a Cu-MOF material (MOF B) produced electrochemically as for Example 2.

In the table below, the determined peak maximum temperatures are listed. As comparison, likewise the boiling points (bp) under standard conditions are given.

| Odor substance | MOF | T_{PM} (° C.) | bp (° C.) |
|---|---|---|---|
| Ammonia | A | 110 | −34 |
| | B | 140 | |
| Benzene | A | 185 | 80 |
| | B | 120 | |
| Hydrogen sulfide | A | 100 | −60 |
| Octane | B | 180 | 125 |

### Example 6

Test Method 1

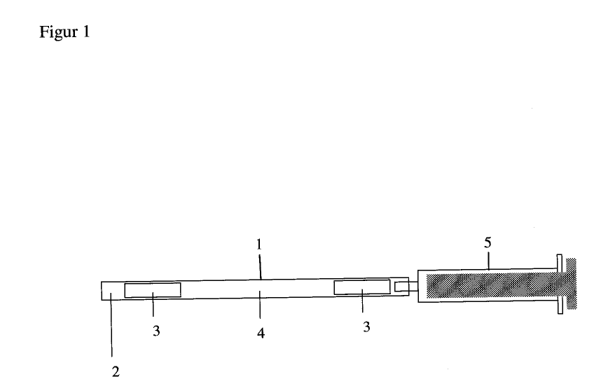

The measurement structure is shown in principle in FIG. 1. According to FIG. 1, the gas under test arrives with the aid of a syringe (5) in a test space (4) of a tube (1) which is partially filled with cotton wadding (3) and has a measurement point (2).

In the present example, 0.2 ml of 25% strength ammonia solution are drawn up into a 5 ml polyethylene syringe. The syringe piston is then filled up to the 5 ml mark with air. The syringe is connected to an approximately 20 cm long polyethylene tube (internal diameter approximately 5 mm). Directly at the syringe attachment, the tube is filled with approximately 2 cm of cotton wadding to prevent solution from passing over into the following gas space. This is followed by an 8 cm long measurement space which is filled with air or adsorbent. This is followed by the measurement point. The measurement is carried out by first forcing the air/ammonia mixture into the tube (avoiding carry out of liquid into the tube). Thereafter the syringe is separated from the tube, filled with air and the resultant air/ammonia mixture is again forced into the tube. This operation is repeated again twice.

The measurement is then carried out using moist pH paper for determining the alkalinity of the exiting gas, and also by odor testing.

The syringe connected to the tube is stored over 16 h at room temperature, and after 16 h a renewed pH and odor test is carried out.

The results are summarized in the table below.

| | | Gas | Result of | Result of | Result of | Result of |
|---|---|---|---|---|---|---|
| | Test | space | pH test, | pH test, | odor test, | odor test, |
| Example | method | filling | 0 h | 16 h | 0 h | 16 h |
| 6-1 (comparison) | 1 | Air | Strongly | Strongly | Very | Strong |
| | | | alkaline | alkaline | strong | ammonia |
| | | | | | ammonia | odor |
| | | | | | odor | |
| 6-2 (comparison) | 1 | Activated | Weakly | Strongly | Weak | Markedly |
| | | carbon | alkaline | alkaline | ammonia | perceptible |
| | | | | | odor | ammonia |
| | | | | | | odor |
| 6-3 | 1 | IRMOF-8 | No | No | No | No |
| | | | reaction | reaction | ammonia | ammonia |
| | | | (neutral | (neutral | odor | odor |
| | | | pH) | pH) | | |

Test Method 2:

5 ml of an atmosphere saturated with aldehyde vapor are taken up into a 5 ml polyethylene syringe. The cotton waddings used in method 1 are replaced in each case by a Sartorius Minisart filtration unit (0.2 μm pore size, 5.3 cm² filter area). In between is situated a 1 cm long packing with adsorbent. The measurement point is situated as in method 1 at the end of structure, the measurement is carried out qualitatively using short-time tubes from Dräger for measuring formaldehyde (2-40 ppm measurement range) and also acetaldehyde (100-1000 ppm measurement range). The length of the discolored zone and the number of syringe strokes are evaluated, and also the results are reported in the table below.

| | | | | Number | |
|---|---|---|---|---|---|
| | | Gas | | of | |
| | Test | space | | syringe | |
| Example | method | filling | Aldehyde | strokes | Test result |
| 6-4 | 2 | Air | Formaldehyde | 1 | Test zone |
| (com- | | | | | completely |
| parison) | | | | | discolored |
| 6-5 | 2 | Air | Acetaldehyde | 1 | Test zone |
| (com- | | | | | completely |
| parison) | | | | | discolored |
| 6-6 | 2 | Al-MOF | Formaldehyde | 2 | Test zone |
| | | | | | partially |
| | | | | | discolored |
| 6-7 | 2 | Al-MOF | Acetaldehyde | 10 | Test zone |
| | | | | | partially |
| | | | | | discolored |
| 6-8 | 2 | Cu-MOF | Formaldehyde | 10 | Test zone |
| | | | | | not |
| | | | | | discolored |
| 6-9 | 2 | Cu-MOF | Acetaldehyde | 10 | Test zone |
| | | | | | partially |
| | | | | | discolored |

1. A method for separating off odor substances from gases the step comprising
contacting the gas with at least one filter comprising a porous metal-organic framework material, the framework material comprising at least one, at least bidentate, organic compound which is bound by coordination to at least one metal ion.

2. The method according to claim 1, wherein the gas is selected from natural gas, biogas, off-gas, air, exhaust air and inert gas.

3. The method according to claim 1, wherein the odor substance is a volatile organic or inorganic compound which comprises at least one of the elements nitrogen, phosphorus, oxygen, sulfur, fluorine, chlorine, bromine or iodine, or is an unsaturated or aromatic hydrocarbon or a saturated or unsaturated aldehyde or ketone.

4. The method according to claim 1, wherein the odor substance is highly volatile.

5. The method according to claim 1, wherein the filter is regenerable.

6. The method according to claim 1, wherein the saturation of the filter (filter material) is recognizable by a color change if the at least one metal ion is a Cu ion.

7. The method according to claim 1, wherein the porous metal-organic framework material is applied to a support material.

8. The method according to claim 1, wherein the porous metal-organic framework material has at least one of the following properties:
a. a specific surface area>5 m²/g (as specified in DIN 66131);
b. the pore size of the crystalline MOF in the range from 0.2 nm to 30 nm; and
c. at least half of the pore volume formed by pores having a pore diameter up to 1000 nm.

9. The method according to claim 1, wherein the porous metal-organic framework material was produced electrochemically.

10. The method according to claim 1, wherein the porous metal-organic framework material comprises Zn, Al, Ni or Cu as metal ion and the at least bidentate organic compound is terephthalic acid, isophthalic acid, 2,4-naphthalenedicarboxylic acid or 1,3,5-benzenetricarboxylic acid.

11. (canceled)
